(19) United States
(12) Patent Application Publication
(10) Pub. No.: US 2008/0201504 A1
(43) Pub. Date: Aug. 21, 2008

(54) USB flash drive capable of providing data security

(75) Inventors: Tim Hsieh, Guanyin Township (TW); Chia-Hsin Wang, Taipei City (TW); Kuo-Chao Hsia, Taipei City (TW)

Correspondence Address: BIRCH STEWART KOLASCH & BIRCH, PO BOX 747, FALLS CHURCH, VA, 22040-0747, US

(73) Assignee: ATP ELECTRONICS TAIWAN, INC.

(21) Appl. No.: 12/071,137

(22) Filed: Feb. 15, 2008

(30) Foreign Application Priority Data
Feb. 16, 2007 (TW) 096203168

(51) Int. Cl. G06F 13/12

(52) U.S. Cl. 710/63

(57) ABSTRACT

The invention discloses a USB flash drive comprising a USB interface, a memory, a flash drive controller, an identification controller and an input interface. The identification controller stores a first ID code. The input interface is used for inputting a second ID code by a user. When the identification controller identifies the second ID code as the first ID code, the identification controller will enable the flash drive controller, such that a computer system can control the flash drive controller to access the memory via the USB interface. When the identification controller cannot identify the second ID code, the identification controller will disable the flash drive controller, such that the computer system cannot control the flash drive controller to access the memory via the USB interface.

### BACKGROUND OF THE INVENTION

1. Field of the Invention

The invention relates to a universal serial bus (USB) flash drive and, more particularly, to a USB flash drive capable of providing data security.

2. Description of the Prior Art

With the advance of technology, there are more and more various storage devices, such as USB flash drive, used for storing digital data. To prevent the data within the USB flash drive from being improperly duplicated or reproduced, the prior arts utilize finger print, ID code or other identification technology to provide data security. However, if the USB flash drive uses finger print or ID code, a computer system usually has to install a driver corresponding the operating system (OS), such as Windows 2000, Windows XP or Linux, so as to execute identification on the computer system for the USB flash drive. In other words, if the computer system does not install the corresponding driver, the conventional USB flash drive cannot be identified and then cannot be operated on the computer system accordingly. It is very inconvenient for the user.

Therefore, the main scope of the invention is to provide a USB flash drive capable of providing data security, so as to solve the aforesaid problems.

### SUMMARY OF THE INVENTION

A scope of the invention is to provide a USB flash drive comprising an input interface and an identification controller. A user can use the input interface to input an ID code, and the identification controller will identify the inputted ID code. Only if the identification controller identifies the inputted ID code as a legal code, a computer system can control the flash drive controller to access the memory via the USB interface.

According to an embodiment, the USB flash drive of the invention comprises a USB interface, a memory, a flash drive controller, an identification controller and an input interface. The USB interface is used for connecting the USB flash drive and a computer system. The flash drive controller is coupled between the USB interface and the memory. The identification controller is coupled to the flash drive controller and stores a first ID code. The input interface is coupled to the identification controller and used for a user to input a second ID code.

In this embodiment, when the identification controller identifies the second ID code as the first ID code, the identification controller enables the flash drive controller, such that the computer system is capable of controlling the flash drive controller to access the memory via the USB interface. On the contrary, when the identification controller cannot identify the second ID code, the identification controller disables the flash drive controller, such that the computer system is incapable of controlling the flash drive controller to access the memory via the USB interface.

Therefore, according to the USB flash drive of the invention, the identification controller can enable or disable the flash drive controller. When the identification controller cannot identify the ID code inputted by a user, the computer system is incapable of accessing the memory via the USB interface. When a user wants to uses any computer system to access the USB flash drive of the invention, he/she only needs to input an ID code by the input interface of the USB flash drive. When the identification controller identifies the inputted ID code as a legal code, the computer system is capable of accessing the memory via the USB interface accordingly. In other words, the computer system does not need to install a specific driver for identifying the USB flash drive. It is very convenient for the user.

The advantage and spirit of the invention may be understood by the following recitations together with the appended drawings.

### BRIEF DESCRIPTION OF THE APPENDED DRAWINGS

FIG. 1 is a functional block diagram illustrating a USB flash drive according to an embodiment of the invention.

FIG. 2 is a functional block diagram illustrating a USB flash drive according to another embodiment of the invention.

### DETAILED DESCRIPTION OF THE INVENTION

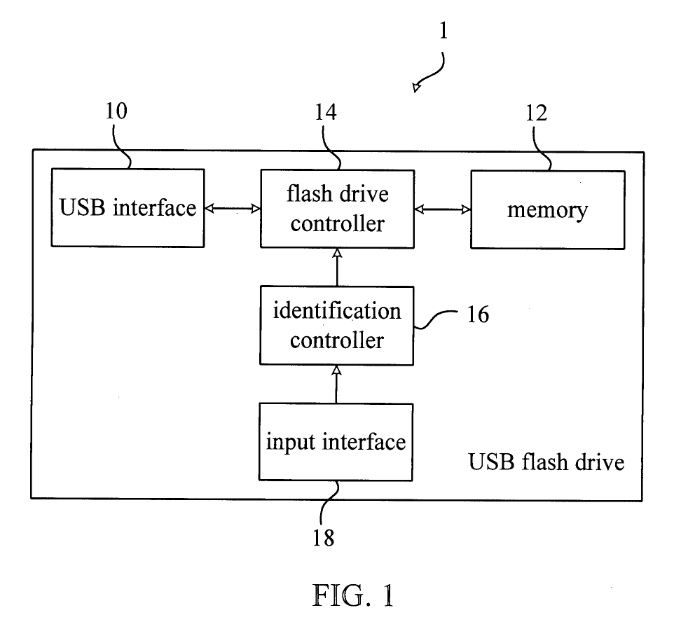

Please refer to FIG. 1. FIG. 1 is a functional block diagram illustrating a USB flash drive 1 according to an embodiment of the invention. The USB flash drive 1 comprises a USB interface 10, a memory 12, a flash drive controller 14, an identification controller 16 and an input interface 18. The memory 12 can be a non-volatile memory, such as flash memory or the like.

As shown in FIG. 1, the flash drive controller 14 is coupled between the USB interface 10 and the memory 12, the identification controller 16 is coupled to the flash drive controller 14, and the input interface 18 is coupled to the identification controller 16. The input interface 18 comprises a plurality of keys (not shown), such that a user can use the keys (not shown) of the input interface 18 to input an ID code.

The USB interface is used for connecting the USB flash drive 1 and a computer system (not shown). That is to say, a user can plug the USB interface 10 into a USB port (not shown) of the computer system (not shown), so as to use the computer system (not shown) to access the memory 12 of the USB flash drive 1.

In this embodiment, a user can use the keys (not shown) of the input interface 18 to input an ID code. When the identification controller 16 identifies the ID code inputted by the user as the preset ID code, the identification controller 16 enables the flash drive controller 14, such that the computer system (not shown) is capable of controlling the flash drive controller 14 to access the memory 12 via the USB interface 10. On the contrary, when the identification controller 16 cannot identify the ID code inputted by the user, the identification controller 16 disables the flash drive controller 14, such that the computer system (not shown) is incapable of controlling the flash drive controller 14 to access the memory 12 via the USB interface 10.

It should be noted that the power for maintaining operation of the USB flash drive 1 can be supplied by the computer system when the USB flash drive 1 is connected to the computer system. Furthermore, the power can also be supplied by a built-in battery. It can be designed by the designer based on practical applications.

Moreover, in practical applications, the identification controller 16 is capable of switching on/off a power pin of the flash drive controller 14 to enable or disable the flash drive controller 14. However, the invention is not limited to the aforesaid manner.

In this embodiment, the USB flash drive of the invention can further comprise a display module (not shown) for displaying the ID code inputted by the input interface 18.

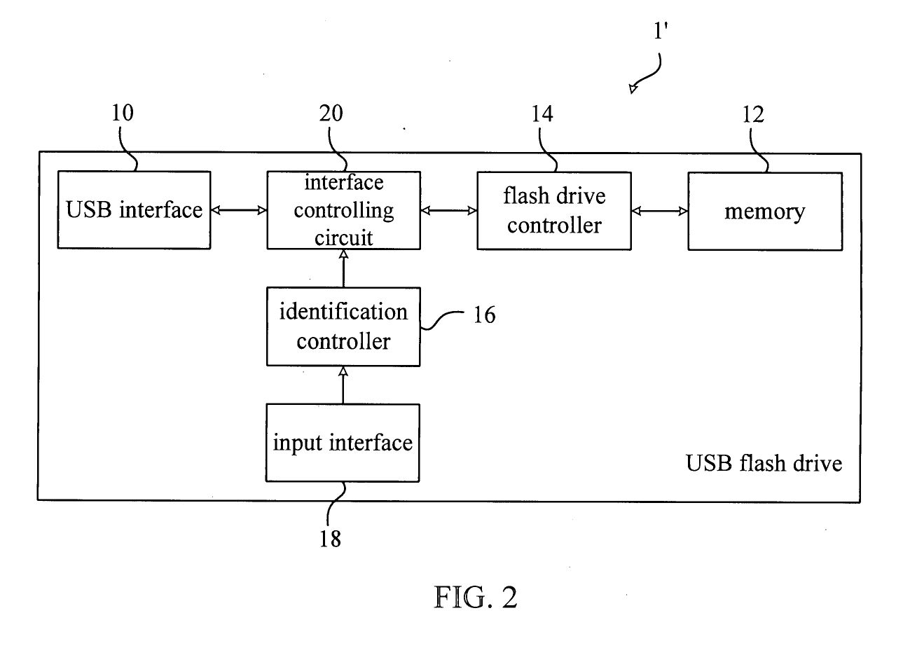

Please refer to FIG. 2. FIG. 2 is a functional block diagram illustrating a USB flash drive 1′ according to another embodiment of the invention. The main difference between the USB flash drive 1′ and the USB flash drive 1 is that the USB flash drive 1′ further comprises an interface controlling circuit 20, which is coupled between the USB interface 10, the flash drive controller 14 and the identification controller 16. The identification controller 16 enables or disables the flash drive controller 14 via the interface controlling circuit 20. The principle of the USB flash drive 1′ shown in FIG. 2 is the same as that of the USB flash drive 1 shown in FIG. 1, and the related description is not mentioned here again.

Compared to the prior art, according to the USB flash drive of the invention, the identification controller can enable or disable the flash drive controller. When the identification controller cannot identify the ID code inputted by a user, the computer system is incapable of accessing the memory via the USB interface. When a user wants to uses any computer system to access the USB flash drive of the invention, he/she only needs to input an ID code by the input interface of the USB flash drive. When the identification controller identifies the inputted ID code as a legal code, the computer system is capable of accessing the memory via the USB interface accordingly. In other words, the computer system does not need to install a specific driver for identifying the USB flash drive. It is very convenient for the user.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A universal serial bus (USB) flash drive comprising:
a USB interface for connecting the USB flash drive and a computer system;
a memory;
a flash drive controller coupled between the USB interface and the memory;
an identification controller, coupled to the flash drive controller, for storing a first ID code; and
an input interface, coupled to the identification controller, for inputting a second ID code;
wherein when the identification controller identifies the second ID code as the first ID code, the identification controller enables the flash drive controller, such that the computer system is capable of controlling the flash drive controller to access the memory via the USB interface, and when the identification controller cannot identify the second ID code, the identification controller disables the flash drive controller, such that the computer system is incapable of controlling the flash drive controller to access the memory via the USB interface.

2. The USB flash drive of claim 1, further comprising an interface controlling circuit coupled between the USB interface, the flash drive controller and the identification controller, wherein the identification controller enables or disables the flash drive controller via the interface controlling circuit.

3. The USB flash drive of claim 1, wherein the memory is a non-volatile memory.

4. The USB flash drive of claim 1, wherein the flash drive controller comprises a power pin, and the identification controller enables or disables the power pin.

5. The USB flash drive of claim 1, further comprising a display module for displaying the second ID code inputted by the input interface.

6. The USB flash drive of claim 1, wherein the input interface comprises a plurality of keys for inputting the second ID code.
